(19) United States
(12) Patent Application Publication
(10) Pub. No.: US 2021/0195067 A1
(43) Pub. Date: Jun. 24, 2021

(54) IMAGING DEVICE ENCLOSURE

(71) Applicant: HEWLETT-PACKARD DEVELOPMENT COMPANY, L.P., Spring, TX (US)

(72) Inventors: Joshua Peter YASBEK, Vancouver, WA (US); Todd GOYEN, Vancouver, WA (US); Robert D. DAVIS, Vancouver, WA (US); Asa WEISS, Vancouver, WA (US); Arthur H. BARNES, Vancouver, WA (US)

(73) Assignee: HEWLETT-PACKARD DEVELOPMENT COMPANY, L.P., Houston, TX (US)

(21) Appl. No.: 16/079,767

(22) PCT Filed: Apr. 14, 2017
(86) PCT No.: PCT/US2017/027683

§ 371 Date: Aug. 24, 2018

(51) Int. Cl. H04N 5/225; H04N 5/232; H04N 5/33

(52) U.S. Cl. CPC H04N 5/2251; H04N 5/33; H04N 5/23296

(57) ABSTRACT

An example system includes an imaging device and an enclosure substantially separating the imaging device from an outside environment. The enclosure includes an air intake to force air into the enclosure and an aperture to allow air to escape the enclosure. The air intake and the aperture maintain an air pressure level in the enclosure greater than an air pressure of the outside environment.

### BACKGROUND

Cameras or other types of imaging devices are commonplace in various manufacturing environments. For example, functionality of robots in manufacturing may rely on vision systems to detect and identify various components. Such vision systems may include various types of imaging devices, such as optical cameras or thermal imaging devices, for example.

### BRIEF DESCRIPTION OF THE DRAWINGS

For a more complete understanding of various examples, reference is now made to the following description taken in connection with the accompanying drawings in which:

FIG. 1 illustrates an example system with an imaging device;

FIG. 2 illustrates another example system;

FIG. 3 illustrates another example system;

FIG. 4 illustrates an example system for three-dimensional printing; and

FIG. 5 is a flow chart illustrating an example method.

### DETAILED DESCRIPTION

Various examples described herein relate to an enclosure for a camera or other imaging device. In various examples, accumulation of contaminants, such as powders or aerosols in a three-dimensional printing environment, on the camera (e.g., on the lens of the camera) is prevented by providing the camera in the enclosure. The enclosure includes an aperture through which the field of view of the camera passes. Thus, the enclosure does not block the view of the camera. An air pressure in the enclosure is maintained at a higher level than the air pressure outside the enclosure, thus preventing contaminants from entering the enclosure. The higher air pressure is maintained by forcing air into the enclosure through an air intake (e.g., a fan). The air is directed out of the aperture while maintaining the higher pressure within the enclosure.

As noted above, vision systems with various types of imaging devices, such as optical cameras or thermal imaging devices, may be used in any of a variety of environments. For example, various manufacturing environments may employ imaging devices to facilitate operation of robots. One example of such a manufacturing environment has developed recently with the rise of three-dimensional (3D) printing technology. In various examples, cameras may be used to identify proper fusion or solidification of a material used in manufacturing of 3D-printed objects. In one example, a thermal camera may be used to detect that the material is reaching a proper or desired temperature for proper fusion.

In such environments, a 3D printer may cause particulates (e.g., powder) or other contaminants that may adhere to a lens or other component of the imaging device to become airborne and accumulate on the imaging device, resulting in interference in the capturing of the image. For example, in the case of a thermal camera, with sufficient accumulation of contaminants, the thermal camera may detect the temperature of the accumulated contaminants rather than the targeted material being fused. Various examples described herein may prevent such accumulation on the imaging device.

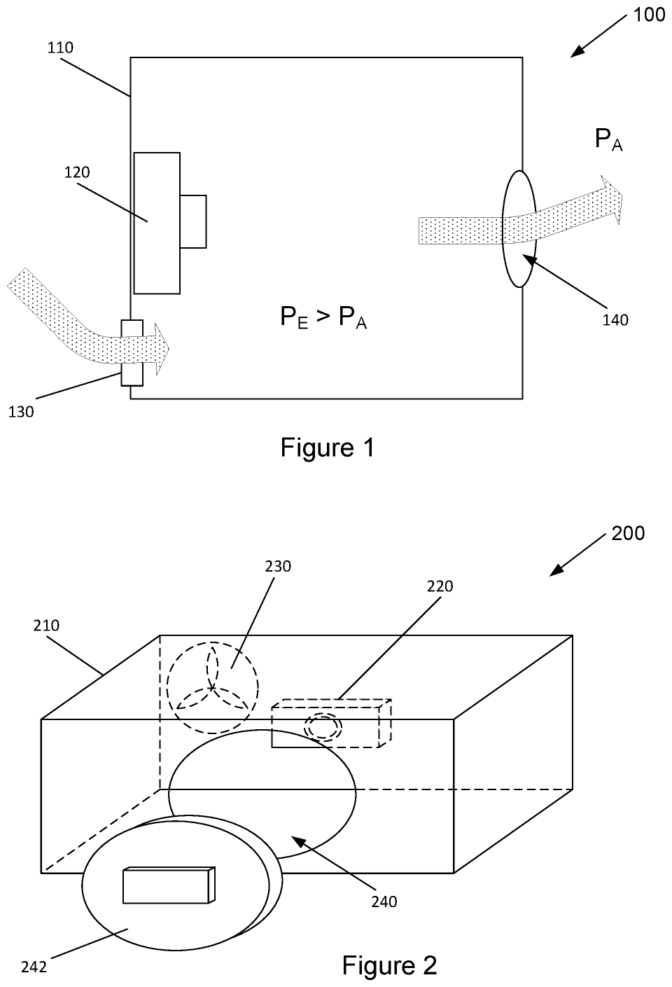

Referring now to FIG. 1, an example system with an imaging device is illustrated. The example system 100 of FIG. 1 includes an enclosure 110 with an imaging device 120 positioned therein. In various examples, the enclosure 110 may be formed of a variety of materials, including metals, plastics or glass, for example. In one example, the enclosure 110 is formed of a transparent or semi-transparent material. Further, the enclosure 110 may be formed in any of a variety of shapes. In one example, as illustrated in the example of FIG. 1, the enclosure 110 is formed in the shape of a rectangular box.

In the example of FIG. 1, the imaging device 120 may be any of a variety of imaging devices, such as cameras. In one example, the imaging device 120 is an optical camera. In another example, the imaging device 120 is a thermal camera for capturing thermal data such as temperature. In various examples, the imaging device 120 may be a light-producing device, such as a laser, for example.

The enclosure 110 substantially separates the imaging device 120 from the environment outside the enclosure 110. In this regard, various examples of the enclosure 110 may isolate and protect the imaging device 120 from contaminants that may be present in the environment outside the enclosure 110. Such contaminants may include dust particles commonly present in the atmosphere or specific contaminants that may be present in the particular environment of the enclosure 110 and the example system 100 of FIG. 1.

In the example system 100 of FIG. 1, the enclosure 110 is provided with an air intake 130 to direct or force air into the enclosure 110. In this regard, the air intake 130 may be a channel and may include a pump, a fan or other device to facilitate flow of air into the enclosure, as illustrated by the large arrow entering the enclosure 110. In various examples, the air forced into the enclosure 110 through the air intake 130 may be clean or purified air that is substantially free of contaminants.

The enclosure 110 of the example system 100 further includes an aperture 140. In this regard, the enclosure 110 may have a body in which the aperture 140 may be formed. Thus, the enclosure 110 substantially surrounds the imaging device 120. The aperture 140 may allow air to escape the enclosure 110. In one example, the air intake 130 and the aperture 140 are sized to maintain an air pressure level in the enclosure 110 (P_{E}) that is greater than the air pressure of the environment outside the enclosure 110 (P_{A}). In this manner, any contaminants that may be present in the environment outside the enclosure 110 are prevented from entering the enclosure 110, thereby protecting the imaging device 120.

In various examples, the aperture 140 may be positioned anywhere on the body of the enclosure 110. In one example, as described in greater detail below, the aperture 140 may be positioned such that the field of view of the imaging device 120 passes, either partly or entirely, through the aperture 140. In various examples, the aperture 140 may be formed with a circular, rectangular or square shape. The shape of the aperture 140 may be selected to correspond to the shape of the field of view of the imaging device 120. In such cases, the aperture 140 may be positioned such that the aperture 140 is concentric with the field of view of the imaging device 120.

Referring now to FIG. 2, another example system 200 is illustrated. The example system 200 of FIG. 2 may be similar to the system 100 of FIG. 1 and includes an imaging device, such as a camera 220, within an enclosure 210. In the example system 200 of FIG. 2, the enclosure 210 is formed in the shape of a rectangular box. As noted above, in other examples, the enclosure 210 may have any of a variety of shapes.

The example system 200 of FIG. 2 includes a fan 230 which functions as an air intake for the enclosure 210. In this regard, the fan 230 may be provided to force air into the enclosure 210. The fan 230 may draw air from outside the enclosure 210 into the enclosure 210. For example, the fan 230 may draw air from the atmosphere outside the enclosure 210. In other examples, the fan 230 may draw air from an air reservoir (not shown) which includes air that is substantially free from contaminants. For example, the air reservoir may include filtered or purified air.

In the example system 200 of FIG. 2, the camera 220 is positioned proximate to one wall of the enclosure 210. An aperture 240 is formed on a wall of the enclosure that is opposite from the camera 220. Positioning the aperture 240 on the opposite wall avoids interference of the body of the enclosure 210 with the field of view of the camera 220. Thus, the camera 220 may have a clear view of the desired subject (not shown) without the view being blocked by the body of the enclosure 210. Further, as noted above, the fan 230 and the aperture 240 are sized to maintain a greater air pressure inside the enclosure 210 than outside the enclosure 210, thus preventing contaminants from outside the enclosure 210 from entering the enclosure 210 through the aperture 240.

The example system 200 of FIG. 2 further includes a cap 242 to allow selectively opening or closing of the aperture 240. In various examples, the cap 242 may be used to close the aperture 240 when the system 200 (e.g., the camera 220) is not in use. In this regard, the cap 242 may protect various components of the camera 220 (e.g., lens) from contaminants. The cap 242 provides an alternative to a lens cap, which may be difficult to install on and remove from the camera 220 within the enclosure. The cap 242 may be removed from the aperture 240 to allow air to flow out of the aperture 240 when the system 200 is in use.

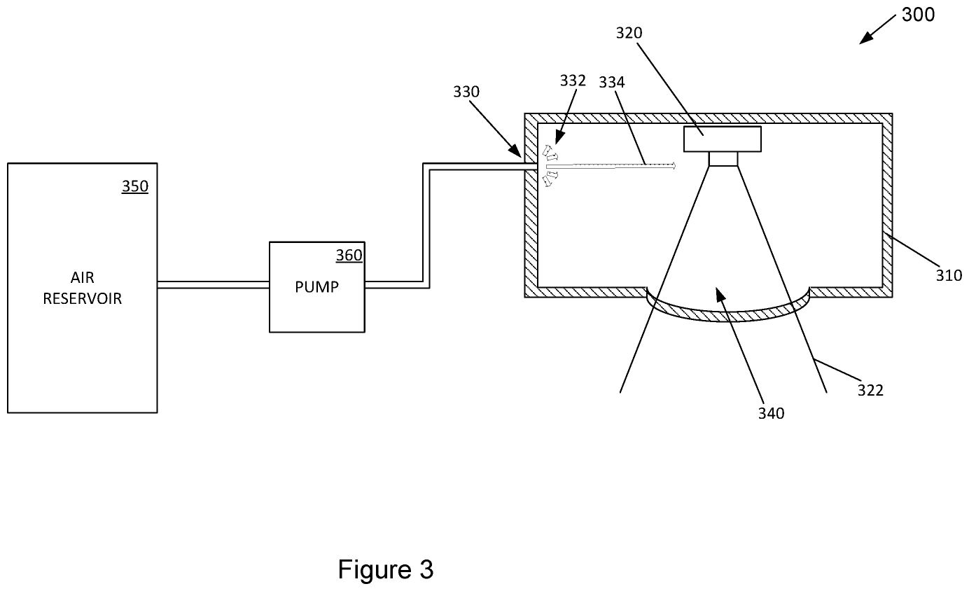

Referring now to FIG. 3, another example system 300 is illustrated. The example system 300 of FIG. 3 includes an enclosure 310 with a camera 320 positioned therein. As noted above, the enclosure 310 substantially isolates the camera 320 from the outside environment. The example system 300 of FIG. 3 includes an air intake 330 through which air is forced into the enclosure 310 and an aperture 340 to allow air to escape from the enclosure 310.

In the example system 300 of FIG. 3, the air intake 330 is coupled to air reservoir 350. As noted above, the air reservoir 350 may include air that is substantially free of contaminants. Air from the air reservoir 350 is delivered to the air intake 330 by a pump 360. The pump 360 may be activated when the system 300 is in use and may be de-activated when the system 300 is not in use. In other examples, the pump 360 may be replaced with a valve coupled to a pressurized air reservoir 350. The valve may be opened during operation and closed during non-use of the system 300.

In the example system 300 of FIG. 3, the pump 360 may be operated to force air into the enclosure 310 in a diffused manner, as indicated by the short arrows 332 in FIG. 3. In another mode, the pump 360 may be operate to cause a strong stream of air to be pulsed, or puffed, onto the camera 320, as indicated by the long arrow 334 in FIG. 3.

The aperture 340 in the enclosure 310 of the example system 300 of FIG. 3 is sized and positioned to allow the field of view 322 of the camera 320 to pass therethrough. In other examples, the aperture 340 may allow at least part of the field of view to pass through the aperture 340. For example, in some cases, the camera 320 may capture the desired subject without use of the entire field of view of the camera 320. Accordingly, the aperture 340 may be sized and positioned to allow sufficient field of view to pass therethrough to capture the desired subject.

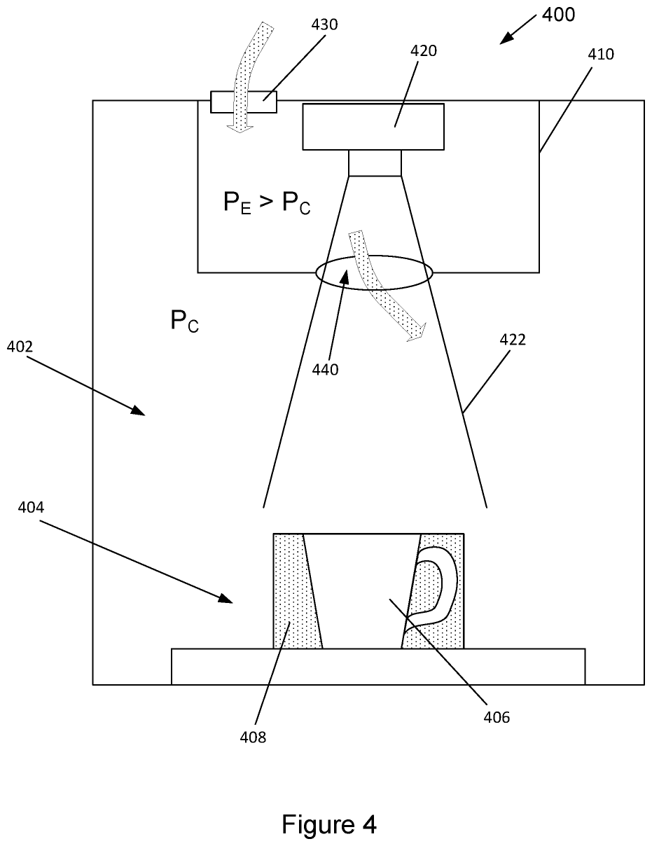

Referring now to FIG. 4, an example system for three-dimensional (3D) printing is illustrated. In various 3D printing systems, a material such as a powder is deposited in layers, and each layer may be fused in selected areas to form a solid object. In the example system 400 of FIG. 4, a chamber 402 is provided with a 3D print build portion 404. Various carriages (not shown) may deposit the material (e.g., powder) in layers in the 3D print build portion 404, and the layer may be fused by, for example, application of a laser (not shown). In other examples, the fusing may be achieved by application of energy or heat from other sources, such as a quartz infrared halogen lamp. FIG. 4 illustrates an example object 406 formed of fused material surrounded by unfused material 408 remaining at each layer.

The example system 400 of FIG. 4 is provided with an enclosure 410 within the chamber 402. The enclosure 410 is similar to the enclosures 110, 210, 310 described above with reference to FIGS. 1-3. As noted above, the enclosure 410 may be formed in any of a variety of shapes such as, for example, a rectangular box. A camera 420 is housed within the enclosure 410. The camera 420 may be provided to, for example, capture images of the 3D print build portion 404 to monitor the 3D printing operation. For example, the camera 420 may be a thermal camera to monitor the temperature of the layers of material to ensure proper fusing.

During operation of the 3D printing system, the powder or other contaminants may travel into various portions of the chamber 402. In this regard, the enclosure 410 substantially isolates the camera 420 from the remainder of the chamber 402 to protect the camera 420 from the contaminants. In order to further protect the camera 420 from the contaminants in the chamber 402, the enclosure 410 is provided with an air intake 430 and an aperture 440 to maintain a higher air pressure within the enclosure (P_{E}) than the air pressure in the chamber (P_{C}). As noted above, air may be forced through the air intake 430 and allowed to escape from the aperture 440. The air intake 430 and the aperture 440 are sized to maintain a desired differential (P_{E}-P_{C}) in the air pressures.

As illustrated in FIG. 4, the example camera 420 has a field of view 422 which at least encompasses a desired portion of the 3D print build portion 404. The aperture 440 in the enclosure 410 is sized and positioned to allow the field of view 422 of the camera 420 to pass through the aperture 440.

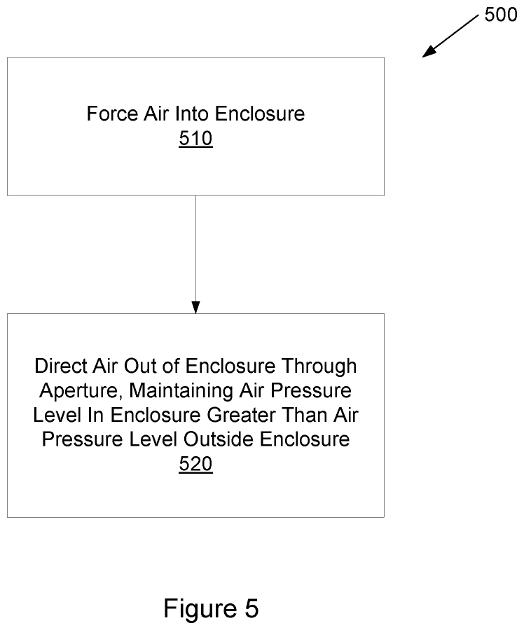

Referring now to FIG. 5, a flow chart illustrates an example method. The example method 500 of FIG. 5 includes forcing air into an enclosure (block 510). As noted above, air may be forced into an enclosure (e.g., the enclosure 110 of FIG. 1) through an air intake (e.g., the air intake 130 of FIG. 1). Further, as described above with reference to FIGS. 1-4, the enclosure includes an imaging device, such as the imaging device 120 of FIG. 1.

The example method 500 further includes directing air out of the enclosure through an aperture (block 520). Forcing air into the enclosure includes forcing sufficient air into the enclosure to maintain an air pressure level in the enclosure greater than an air pressure outside the enclosure. As described above with reference to FIG. 1, the air intake 130 and the aperture 140 are sized to maintain an air pressure level in the enclosure 110 (P_{E}) that is greater than the air pressure of the environment outside the enclosure 110 (P_{A}).

Thus, in accordance with various examples described herein, accumulation of contaminants, such as powders or aerosols in a three-dimensional printing environment, on an imaging device is prevented by providing the imaging device in an enclosure. An aperture allows the field of view of the imaging device to pass therethrough. An air pressure difference prevents contaminants from entering the enclosure, thereby protecting the imaging device.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
an imaging device; and
an enclosure substantially surrounding the imaging device, the enclosure comprising:
an air intake to force air into the enclosure; and
an aperture to allow air to escape the enclosure,
wherein the air intake and the aperture are to maintain an air pressure level in the enclosure greater than an air pressure of an outside environment.

2. The system of claim 1, wherein a field of view of the imaging device at least partly passes through the aperture.

3. The system of claim 2, wherein the aperture and the field of view are concentric.

4. The system of claim 2, wherein the field of view passes completely through the aperture.

5. The system of claim 1, wherein the imaging device is one of a camera or a laser.

6. The system of claim 5, wherein the imaging device is a thermal camera to capture thermal data.

7. The system of claim 1, wherein the enclosure includes a body, the aperture being formed in the body, the body of the enclosure being outside the field of view of the imaging device.

8. The system of claim 1, further comprising:
an air reservoir to provide air to the air intake, wherein the air reservoir includes air substantially free of contaminants.

9. A method, comprising:
forcing air into an enclosure, the enclosure including an imaging device therein;
directing the air out of the enclosure through an aperture,
wherein forcing air into the enclosure includes forcing sufficient air into the enclosure to maintain an air pressure level in the enclosure greater than an air pressure outside the enclosure.

10. The method of claim 9, wherein forcing air into the enclosure includes activating a fan to direct air into the enclosure.

11. The method of claim 9, wherein directing the air out of the enclosure includes removing a cap from the aperture to allow air to flow out of the aperture.

12. The method of claim 9, further comprising:
wherein a field of view of the imaging device passes through the aperture.

13. A system, comprising:
a chamber housing a three-dimensional print build portion;
an enclosure within the chamber; and
a camera housed within the enclosure, the enclosure substantially isolating the camera from a remainder of the chamber, the camera having a field of view,
wherein the enclosure includes an air intake and an aperture, the field of view of the camera passing through the aperture.

14. The system of claim 13, further comprising:
an air supply coupled to the air intake, the air supply including air substantially free from contaminants.

15. The system of claim 13, wherein the air intake is to force air into the enclosure and the aperture is to route air out of the enclosure to generate an air pressure within the enclosure that is greater than the air pressure in the remainder of the chamber.
